(19) United States
(12) Patent Application Publication
(10) Pub. No.: US 2016/0321750 A1
(43) Pub. Date: Nov. 3, 2016

(54) COMMODITY PRICE FORECASTING

(71) Applicant: FUJITSU LIMITED, Kawasaki-shi (JP)

(72) Inventors: Dawei HE, San Jose, CA (US); Wei-Peng CHEN, Fremont, CA (US)

(21) Appl. No.: 14/701,448

(22) Filed: Apr. 30, 2015

(51) Int. Cl. G06Q 40/04; G06N 5/04; G06N 99/00

(52) U.S. Cl. CPC G06Q 40/04; G06N 99/005; G06N 5/04

(57) ABSTRACT

A method to forecast a price of a commodity may include obtaining a particular time in the future for a price forecast of the commodity and obtaining previous price information of the commodity. The method may also include decomposing the price information into spike price information and non-spike price information and determining a non-spike price at the particular time using the non-spike price information. The method may also include determining whether a price spike occurs at the particular time based on the price information. The method may also include providing a forecasted price of the commodity at the particular time. The forecasted price of the commodity may be the non-spike price in when the price spike does not occur and being a spike price when the price spike does occur. The spike price determined based on the spike price information using a third machine learning price algorithm.

### FIELD

The present disclosure relates to commodity price forecasting.

### BACKGROUND

Price forecasting in commodities, such as electricity, has become increasingly important. Price forecasting may range from long-term to short-term forecasting. Long-term and medium-term price forecasting may be used for investment and maintenance objectives. Short-term, such as real-time, forecasting may be used for operation purposes by market operators of the commodity and generators of the commodity. For example, generators of electricity may use real-time price forecasting to determine when and how much to bid for supplying electricity to a marketplace. Others may also use real-time price forecasting for electricity. For instance, retailers and demand response aggregators may use real-time forecasting when determining how to integrate smaller consumers into demand response strategies.

The subject matter claimed herein is not limited to embodiments that solve any disadvantages or that operate only in environments such as those described above. Rather, this background is only provided to illustrate one example technology area where some embodiments described herein may be practiced.

### SUMMARY

According to an aspect of an embodiment, a method to forecast a price of a commodity may include obtaining a particular time in the future for a price forecast of the commodity. The method may also include obtaining previous price information of the commodity based on the particular time. The method may further include decomposing the price information into spike price information and non-spike price information based on a spike price threshold and determining, using a first machine learning price algorithm, a non-spike price at the particular time using the non-spike price information. The method may also include determining, using a second machine learning price algorithm, whether a price spike occurs at the particular time based on the price information. The method may also include providing a forecasted price of the commodity at the particular time. The forecasted price of the commodity may be the non-spike price in response to the determination that the price spike does not occur at the particular time and the forecasted price of the commodity may be a spike price in response to the determination that the price spike occurs at the particular time. The spike price at the particular time may be determined based on the spike price information using a third machine learning price algorithm.

The object and advantages of the embodiments will be realized and achieved at least by the elements, features, and combinations particularly pointed out in the claims.

It is to be understood that both the foregoing general description and the following detailed description are exemplary and explanatory and are not restrictive of the present disclosure, as claimed.

### BRIEF DESCRIPTION OF THE DRAWINGS

Example embodiments will be described and explained with additional specificity and detail through the use of the accompanying drawings in which:

FIG. 1 illustrates an example process to forecast price of a commodity;

FIG. 2a illustrates an example graph of price information of a commodity over time;

FIG. 2b illustrates an example graph of non-spike price information of the commodity over time based on the price information of FIG. 2a;

FIG. 2c illustrates an example graph of spike price information of the commodity over time based on the price information of FIG. 2a;

FIG. 3 illustrates an example system configured to forecast price of a commodity;

FIG. 4 is a flow chart of an example method to forecast price of a commodity; and

FIG. 5 is a flow chart of another example method to forecast price of a commodity.

### DESCRIPTION OF EMBODIMENTS

Some embodiments described in this application relate to a system and method to forecast a price of a commodity, such as oil, gas, electricity, water, among other commodities.

In some circumstances, a commodity market may exist for buying and selling a commodity. The time between the bidding and clearing process may be relatively short, for example every 5, 10, 15, or 30 minutes or some other interval of time. In these and other embodiments, clearing and bidding processes that occur in less than 30 minutes may be referred to herein as real-time pricing of the commodity. Due to recent changes in technology that allow for the real-time pricing of commodities, buyers and sellers may submit bidding prices in real-time.

Typically, prices of commodities may be volatile and contain price spikes. Price spikes may include instances where the price of the commodity moves in a comparatively large upward or downward trend in a short period of time. For example, in some circumstances, clearing and bidding process for electricity may occur every five minutes. In these and other embodiments, the price may be $100 per megawatt hour (Mwh) at time A and five minutes later at time B, the price may be $300/Mwh. The change of the price between time A and time B may be a price spike. Due to the volatility in the prices of commodities, it may be very difficult to submit selling and bidding prices within a proper risk tolerance in real-time.

To allow buyers and sellers to help manage risk when submitting prices and bids for a commodity, the system and method described in at least some embodiments in this application forecast a price of a commodity at a particular future time. Due to the volatile and price spikes of commodity prices, the system and method described in at least some embodiments in this application apply a bi-level price forecast to forecast the price of a commodity at a particular future time.

A bi-level price forecast generates a trending price that does not compensate for price spikes. The trending price is referred to herein as a non-spike price. The bi-level price forecast may also generate a spike price for potential price spikes. Thus, the price forecast may generate bi-level prices, that is the non-spike price and the spike price. To determine whether to use the non-spike price or the spike price, the system and method described in at least some embodiments in this application may determine if a price spike may occur. When a price spike is determined to occur, the spike price may be used for the forecasted commodity price at the particular future time. When a price spike is determined to not occur, the non-spike price may be used for the forecasted commodity price at the particular future time.

Embodiments of the present disclosure will be explained with reference to the accompanying drawings.

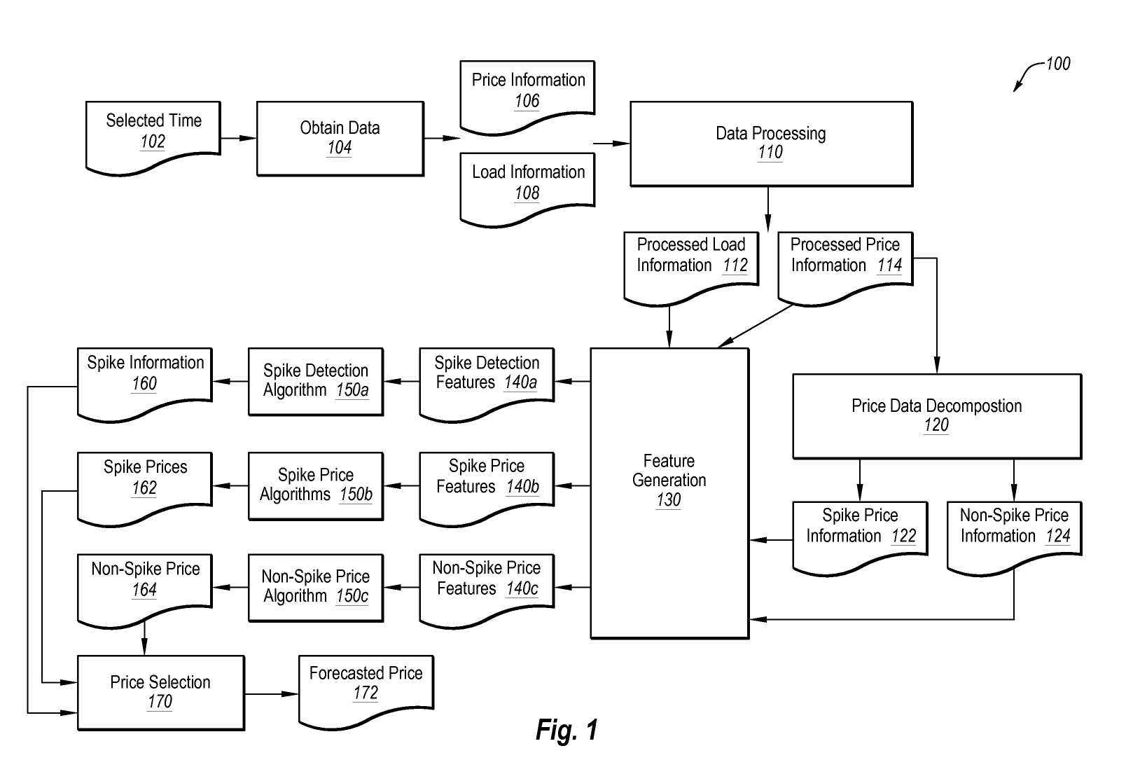

FIG. 1 illustrates an example process 100 to forecast price of a commodity, arranged in accordance with at least one embodiment of the present disclosure. The process 100 may forecast price of a commodity at a future time based on price information and load information for the commodity. In general, the process 100 may forecast price of a commodity using a bi-level price strategy.

To forecast a price of the commodity, the process 100 obtains a particular time 102 in future for which the price of the commodity is to be forecasted. In some embodiments, the time 102 may be provided automatically by another system that is requesting the forecast price or by a user of a system performing the process 100 or communicating with the system performing the process 100. In some embodiments, the process 100 may obtain the time 102 based on the time of the request to forecast a price. For example, in some embodiments, the process 100 may forecast a price at a particular time ahead of when a request is received.

The time 102 may a single time in the future or multiple times in the future. The process 100 is described with respect to FIG. 1 with respect to a single time in the future. However, the process 100 may operate to forecast prices at multiple times by performing multiple iterations. In some embodiments, some data used or generated in one iteration may be used in additional iterations.

In some embodiments, the time 102 may have a granularity associated with a time granularity of bidding and selling on a commodity market of the commodity. For example, the commodity market for electricity sells and buys electricity at five (5) minute intervals. In these and other embodiments, the time 102 obtained may correspond to the intervals of the commodity market of the commodity. Alternately or additionally, the process 100 may obtain any time and may process the time such that is correspond with the time intervals of the commodity market of the commodity.

Based on the time 102, the process 100 may obtain data 104 regarding the price and load of the commodity. In some embodiments, price information 106 may be obtained about the commodity. Alternately or additionally, load information 108 may be obtained about the commodity. In some embodiments, the price information 106 and the load information 108 may be obtained from the commodity market that handles the selling and buying of the commodity.

In some embodiments, the price information 106 may include multiple different types of price information. The different types of the price information 106 may include first and second previous price data. For example, in some embodiments, the first previous price data may be actual price data of a first period that is a first time before the time 102 and the second previous price data may be actual price data of a second period that is a second time before the time 102. In some embodiments, the first and second previous price data may provide price data for multiple buying and selling periods of the commodity market. In some embodiments, the price information 106 may include a difference between the first and second previous price data.

In some embodiments, the first period may be a period within a few hours of the time 102 to capture current price data trends of the commodity. In some embodiments, the first period may be a period associated with the latest real-time price data of the commodity. The second period may be a period during the same time of day as the time 102 but during a previous day. The second period may assist the process 100 in determining common price trends for the commodity during common hours of the day. For example, electricity prices during the noon hour a day before may be more representative of electricity prices during the noon hour of the current day than electricity prices between 2 and 3 A.M. the day before.

As an example of the first and second periods, when the commodity market buys and sells every five (5) minutes, the first period may be one hour that spans from two hours to one hour before the time 102. The second period may also be one hour that spans from twenty-four hours to twenty-three hours before the time 102. For example, if the time 102 is 12:05 P.M. on April 14, the first previous price data may be 12 equally spaced data points of actual price data of the commodity from 10:05 A.M. to 11:05 A.M. on April 14. The second previous price data may be 12 equally spaced data points of actual price data of the commodity from 12:05 P.M. to 1:05 P.M. on April 13. In some embodiments, the first and second periods may be different lengths.

Another type of price information 106 may include a future market clearing price. A future market clearing price may be a predicted price of the commodity at a lower granularity than the requested forecast price and the timing for bidding and clearing of the commodity. For example, the commodity market may accept bids and clear the commodity every 5 minutes. The future market clearing price may provide an estimated price for every hour on the hour. Thus, the future market clearing price may provide an estimate for one or every twelve buying and clearing periods.

In some embodiments, the load information 108 may include multiple different types of load information. The different types of the load information 108 may include previous load data and forecasted load data. In some embodiments, the previous load data may be the actual load data of a load period that is before the time 102. The load period of the previous load data may assist the process 100 in determining current load trends of the commodity. In some embodiments, the load information 108 may include a difference between the previous load data and the forecasted load data.

As an example of the load period when the commodity market buys and sells every 5 minutes, the load period may be one hour that spans from two hours to one hour before the time 102. For example, if the time 102 is 12:05 P.M. on April 14, the previous load data may be 12 equally spaced data points of actual load data of the commodity from 10:05 A.M. to 11:05 A.M. on April 14.

A forecasted load data may be a predicted load of the commodity at a lower granularity than the requested forecast price and the timing for bidding and clearing of the commodity. For example, the commodity market may accept bids and clear the commodity every 5 minutes and provide load information every 5 minutes. The forecasted load data may provide an estimated load for every hour on the hour. Thus, the forecasted load data may provide an estimate for one or every twelve bidding and clearing periods.

The process 100 may perform data processing 110 on the price information 106 and the load information 108. The data processing 110 may include removing bad data and interpolating missing data from the price information 106 and the load information 108. For example, the load information 108 may include load points that indicate that the load is zero. These load points may be replaced with adjusted load values that are interpolated based on neighboring load points. As another example, the price information 106 may include price points that are below zero or zero. These price points may be replaced with adjusted price values that are interpolated based on neighboring price points. The data processing 110 may generate processed load information 112 and processed price information 114.

The process 100 may perform price data decomposition 120 on the processed price information 114 to generate spike price information 122 and non-spike price information 124. The price data decomposition 120 may include identifying and removing price spikes from the processed price information 114.

Price spikes of the processed price information 114 may be identified based on a spike price threshold. The spike price threshold may be determined based on the stability of the price of the commodity. For example, the spike price threshold may be set at a value such that eighty (80) percent of the prices of the commodity within a given time frame are lower than the spike price threshold. In some embodiments, commodity markets with higher price stability may have a higher percent of prices within a given time frame that are lower than the spike price threshold than commodity markets with lower price stability. Alternately or additionally, the spike price threshold may be variable as the stability of the price may vary over time. For example, electricity stability may be different during spring than during summer. In some embodiments, the spike price threshold may be determined based on a knee point of a frequency of the prices in the commodity market.

To generate the non-spike price information 124, the identified price spikes from the processed price information 114 may be removed. Removing the identified price spikes may include change the price value of the identified price spikes to an interpolated value based on neighboring non-spike price values.

To generate the spike price information 122, the identified price spikes from the processed price information 114 may be reduced with the interpolated value for the identified price spikes that replace the price spikes in the non-spike price information 124. Non-spikes prices may be removed. As a result, the spike price information 122 may include the identified prices spikes with the adjusted values.

Note that the price data decomposition for each of the different types of price information may be performed individually. Thus, the first previous price data may be price data decomposed based on the first previous price data. The second previous price data may be price data decomposed based on the second previous price data and the future market clearing price may be price data decomposed based on the future market clearing price.

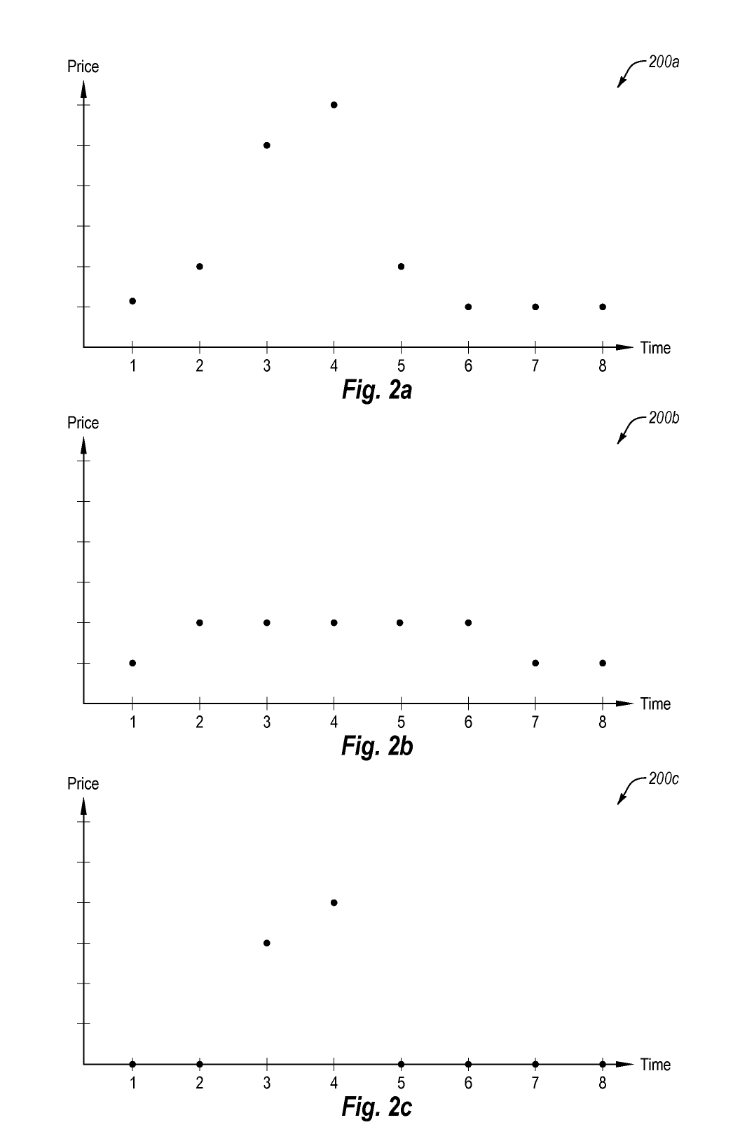

FIGS. 2a-2c illustrate price data decomposition accordingly to at least one embodiment of the present disclosure. In particular, FIG. 2a illustrates an example graph 200a of one type of price information of a commodity with respect to time, arranged in accordance with at least one embodiment of the present disclosure. The graph 200a includes an x-axis that represents time and a y-axis that represents a price value. The graph 200a illustrates eight (8) different times. The eight (8) times may correspond to eight (8) data points of one type of price information, such as the first previous price data, the second previous price data, or the future market clearing price data. For example, the eight (8) data points may be a spot price at eight (8) consecutive bidding and clearing prices of a commodity or some selected increment of bidding and clearing prices. As illustrated, price points at times 3 and 4 may have price values that are higher than a spike price threshold.

FIG. 2b illustrates an example graph 200b of non-spike price information of the commodity over time based on the price information of FIG. 2a, arranged in accordance with at least one embodiment of the present disclosure. The graph 200b is similar to the graph 200a expect that it does not include the prices spikes at times 3 and 4. The values of the price at times 3 and 4 have been replaced with the interpolated values based on the values at times 2 and 5, which are neighbors of times 3 and 4. The interpolated values based on the values at times 2 and 5 result in the values of the price at times 3 and 4 being equal to the values at times 2 and 5 as illustrated in graph 200b.

FIG. 2c illustrates an example graph 200c of spike price information of the commodity over time based on the price information of FIG. 2a, arranged in accordance with at least one embodiment of the present disclosure. The graph 200c is similar to the graph 200a expect that it does not include prices at the times when the graph 200a includes non-spike prices. Thus, the graph 200c includes a zero price at times 1, 2, 5, 6, 7, and 8. The graph 200c further includes values at the times of the price spikes, times 3 and 4, of the graph 200a. The value at the times 3 and 4 are equal to a difference between the values of at times 3 and 4 in the graph 200a and the interpolated values at times 3 and 4 in the graph 200b.

Returning to FIG. 1, in some embodiments, the price data decomposition 120 of the processed price information 114 may occur using a moving-average filter of prices values with a rolling window that compares the spike price threshold. In these and other embodiments, the rolling window size may be based on an average length of spike events. In some embodiments, the rolling window size for a commodity market that includes bidding and clearing price points that occur every five (5) minutes may include three (3) to six (6) price points. In these and other embodiments, a moving-average filter may be applied to the non-spike price information 124 after the price spikes have been removed to smooth the prices in the non-spike price information 124.

After generating the non-spike price information 124 and the spike price information 122, the process 100 may perform feature generation 130 using the processed load information 112, the processed price information 114, the spike price information 122, and the non-spike price information 124. The features generated by the feature generation 130 may be includes spike detection features 140a, spike price features 140b, and non-spike price features 140c, collectively referred to in this application as the features 140.

The spike detection features 140a may be generated using the processed price information 114 and the processed load information 112. The spike price features 140b may be generated using the processed load information 112 and the spike price information 122 without using the non-spike price information 124 or the processed price information 114. The non-spike price feature 140c may be generated using the processed load information 112 and the non-spike price information 124 without using the spike price information 122 or the processed price information 114.

In some embodiments, the spike detection features 140a, the spike price features 140b, and the non-spike price features 140c may include similar features or non-similar features. Various features that may be included in the spike detection features 140a, the spike price features 140b, and the non-spike price features 140c are now described. The discussion that follows regarding the various features refers generally to price data. The price data may represent the processed price information 114, the spike price information 122, and the non-spike price information 124. For example, if the discussed features are the non-spike price features 140c, then the price data would represent the non-spike price information 124.

The features 140 generated by the feature generation 130 may include a spike feature, a load feature, a comparison load feature, a seasonal feature, a type of day feature, a hourly price variance feature, a price data feature, a demand price ratio feature, an elastic feature, and a spike series length feature, among other features.

The spike feature may indicate if a spike occurred in the first previous price data. The load feature may include a normalization of the previous load data of the load information 108. A generic normalization equation may be applied when generating the features 140. The generic normalization equation may normalize the data by taking a difference between a value of a data point at a time t and a lowest value in the data set and dividing the difference by a difference between a maximum value and the lowest value in the data set. The result is used to replace the value of the data point at time t such that the data point at time t is normalized.

The comparison load feature may be a difference between normalized forecasted load data and normalized previous load data. The seasonal feature may be a number that indicates a season, such as spring (March to May), summer (June to August), fall (September to November), and winter (December to February), of the day for the forecasted price being generated. The seasonal feature may be used when training data used to generate algorithms, such as a spike detection algorithm 150a, spike price algorithms 150b, and a non-spike price algorithm 150c that may use the features as inputs included data from multiple different seasons. If the training data included information from a single season or the commodity's price does not vary based on a season, then the seasonal feature may not be used.

The type of day feature may be a number that indicates if the day for the forecasted price being generated is a weekday or a weekend. The day feature may be used when training data used to generate algorithms, such as a spike detection algorithm 150a, spike price algorithms 150b, and a non-spike price algorithm 150c that may use the features as inputs included data from every day of the week. If the training data included information from weekend or weekdays but not both or the commodity's price does not vary based on a whether it is a weekend or weekday, then the day feature may not be used.

The hourly price variance feature may a number that represents a variation of the first previous price data. The price data feature may include a normalization of the one or more of a first and second previous price data and the future market clearing price.

The demand price ratio feature may include a comparison between the previous load data and the first previous price data after the previous load data and the first previous price data are normalized. The elastic feature may include a comparison between a change over time of the previous load data and a change over time of the first previous price data after the previous load data and the first previous price data are normalized. The spike series length feature may describe the number of consecutive price points that are price spikes. In some embodiments, the spike series length feature may be a number that is one less than the number of consecutive price points that are price spikes from the first previous price data.

In some embodiments, each of the spike detection features 140a, the spike price features 140b, and the non-spike price features 140c may include all of the features described herein among other features generated using the particular price data for that feature group. Alternately or additionally, each of the spike detection features 140a, the spike price features 140b, and the non-spike price features 140c may include one or more of the features herein among other features generated using the particular price data for that feature group.

For example, in some embodiments, the spike detection features 140a may include the spike feature, the load feature, the comparison load feature, the seasonal feature, the type of day feature, the hourly price variance feature, the price data feature, and the spike series length feature. These features may be generated using the processed price information 114 that includes the price spikes.

In these and other embodiments, the spike price features 140b may include the spike feature, the comparison load feature, the price data feature, the demand price ratio feature, and the spike series length feature. These features may be generated using the spike price information 122 and not using the non-spike price information 124 or the processed price information 114.

In these and other embodiments, the non-spike price features 140c may include the load feature, the comparison load feature, the seasonal feature, the type of day feature, the hourly price variance feature, the price data feature, the demand price ratio feature, and the elastic feature. These features may be generated using the non-spike price information 124 and not using the spike price information 122 or the processed price information 114.

The spike detection features 140a may be provided to the spike detection algorithm 150a. The spike price features 140b may be provided to the spike price algorithms 150b and the non-spike price features 140c may be provided to the non-spike price algorithm 150c. The spike detection algorithm 150a, the spike price algorithms 150b, and the non-spike price algorithm 150c may be referred to in this application as the algorithms 150.

The algorithms 150 may result from machine learning algorithms that were previously trained using data similar to the price information 106 and the load information 108. In some embodiments, the algorithms 150 may each result from the same type of machine learning algorithms and may each be trained with similar or different data. In some embodiments, the algorithms 150 may each result from different types of machine learning algorithms. For example, the spike detection algorithm 150a may result from a binary classification machine learning algorithm, such as a support vector machine algorithm. The spike price algorithms 150b may result from a clustering machine learning algorithms such as a self-organizing map algorithm or a k-means clustering algorithm. The non-spike price algorithm 150c may result from a neural network type machine learning algorithm.

In some embodiments, the spike price algorithms 150b may include multiple algorithms developed based on the same clustering algorithm. In these and other embodiments, the training data used to develop each of the spike price algorithms 150b may be different. For example, the training data may include multiple features based on load information and previous spike-price information of the commodity. To develop each of the spike price algorithms 150b, a different subset of the multiple features and/or different initial training parameters may be provided to the clustering algorithm to develop one of the spike price algorithms 150b. Thus, each of the spike price algorithms 150b may be similar but different enough to generate a probabilistic array of outputs with the same inputs. In some embodiments, the process 100 may use 10, 20, 50, 100, 500, 1000, or 5000 different spike price algorithms 150b.

The spike detection algorithm 150a may be provided with the spike detection features 140a as input. The spike detection algorithm 150a may generate spike information 160. The spike information 160 may indicate if a price spike is forecasted to occur or not to occur at the time 102. In some embodiments, the spike information 160 may be binary and thus may forecast a price spike or no price spike. Alternately or additionally, the spike information 160 may provide a probability for an occurrence of the price spike at the time 102.

Each of the spike price algorithms 150b may be provided with the spike price features 140b. The spike price algorithms 150b may each generate a spike price that result in the spike prices 162. Thus, in these and other embodiments, the spike price algorithms 150b may generate 10, 20, 50, 100, 500, 1000, or 5000 different spike prices 162 based on a number of the spike price algorithms 150b. The non-spike price algorithm 150c may be provided with the non-spike price features 140c. The non-spike price algorithm 150c may generate a non-spike price 164.

The process 100 may perform a price selection 170 to determine a forecasted price 172 of the commodity at the time 102 based on the spike information 160. When the spike information 160 forecasts no price spike at the time 102, the non-spike price 164 may be the forecasted price 172 of the commodity at the time 102. When the spike information 160 forecasts a price spike at the time 102, the forecasted price 172 of the commodity at the time 102 may be based on the spike prices 162. In some embodiments, the price selection 170 may determine the forecasted price 172 of the commodity at the time 102 based on the spike prices 162 by determining a mean or medium of the spike prices 162.

Alternately or additionally, the spike prices 162 may indicate a posterior distribution of the forecasted price 172 of the commodity at the time 102. In these and other embodiments, the spike prices 162 may be used to determine a confidence interval with respect to the forecasted price 172 being a mean of the spikes prices 162. To construct the confidence interval, a density and distribution of the forecasted price 172 being a mean of the spikes prices 162 may be determined using any distribution such as a Brownian motion or Gaussian distribution. The confidence interval may include an upper bound price and a lower bound price for the forecasted price 172 for a spike. In some embodiments, the confidence interval may be eighty (80), ninety (90), or ninety-five (95) percent confidence interval or some other percent confidence interval.

Modifications, additions, or omissions may be made to the process 100 without departing from the scope of the present disclosure. For example, in some embodiments, the process 100 may include a single spike price algorithm 150b. Alternately or additionally, the process 100 may generate the spike prices after determining that a price spike is forecasted to occur at the time 102 based on the spike information 160. In these and other embodiments, the spike price features 140b may be generated after the determination that price spike is forecasted to occur at the time 102 based on the spike information 160. Alternately or additionally, the price data decomposition 120 may occur after the generation of the spike information 160 such that the process 100 may avoid generating the spike price information 122, the spike price features 140b, and the spike prices 162 if the spike information forecasts that a spike is not going to occur at the time 102.

In some embodiments, the process 100 may operate to forecast the price at multiple different times by performing multiple iterations. In these and other embodiments, some data used or generated in one iteration may be used in additional iterations. For example, processed load information 112, processed price information 114, the spike price information 122, the non-spike price information 124, or the spike price features 140b from a first price forecast may be used in a second price forecast.

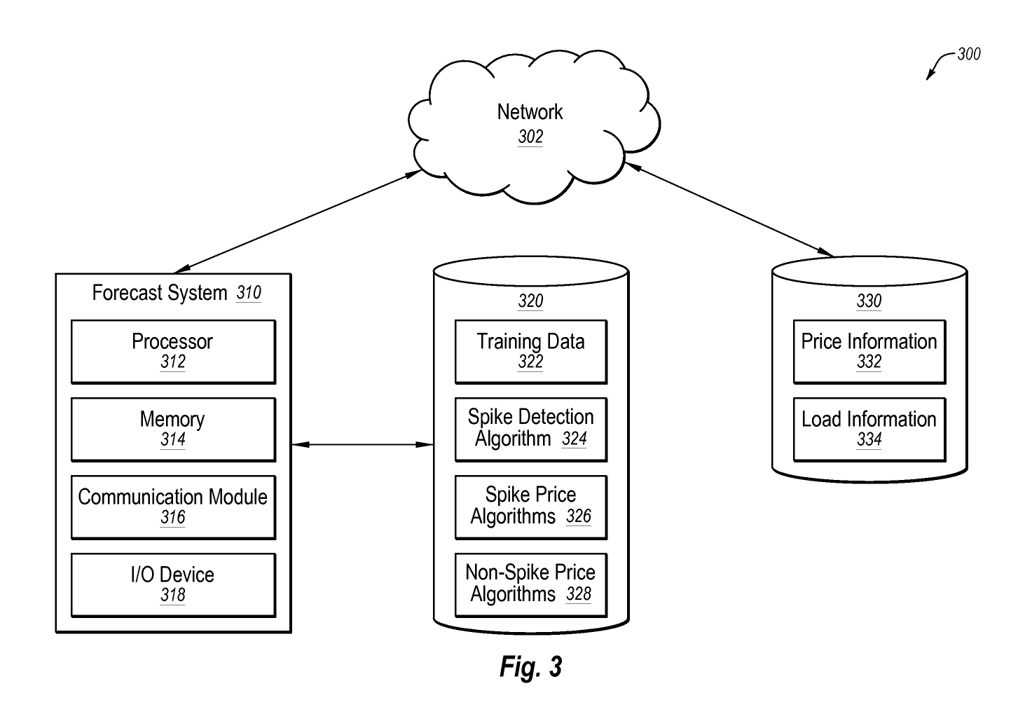

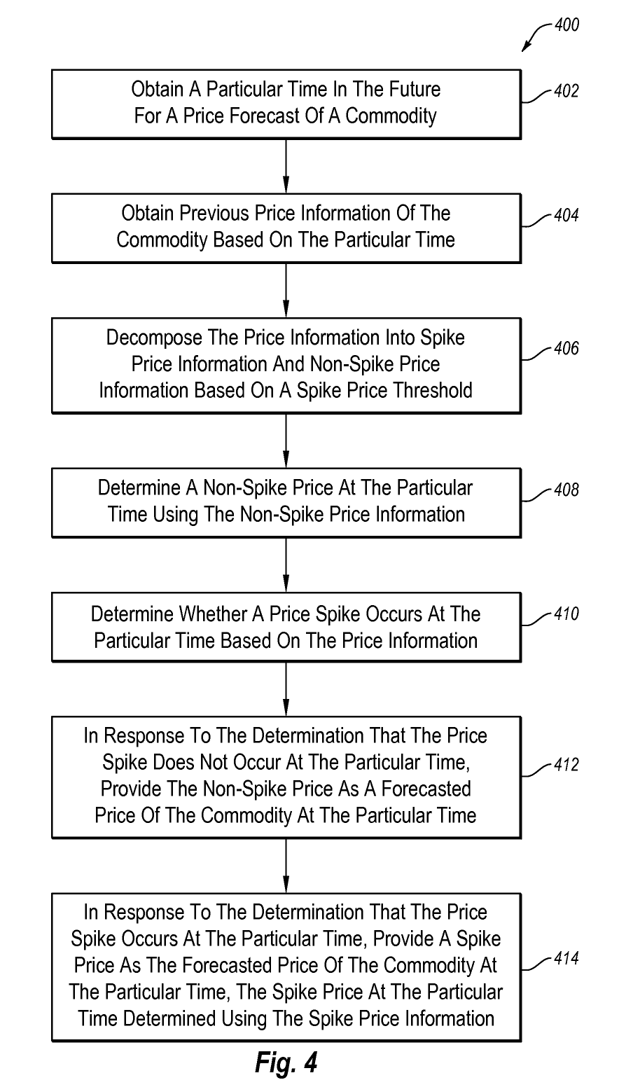

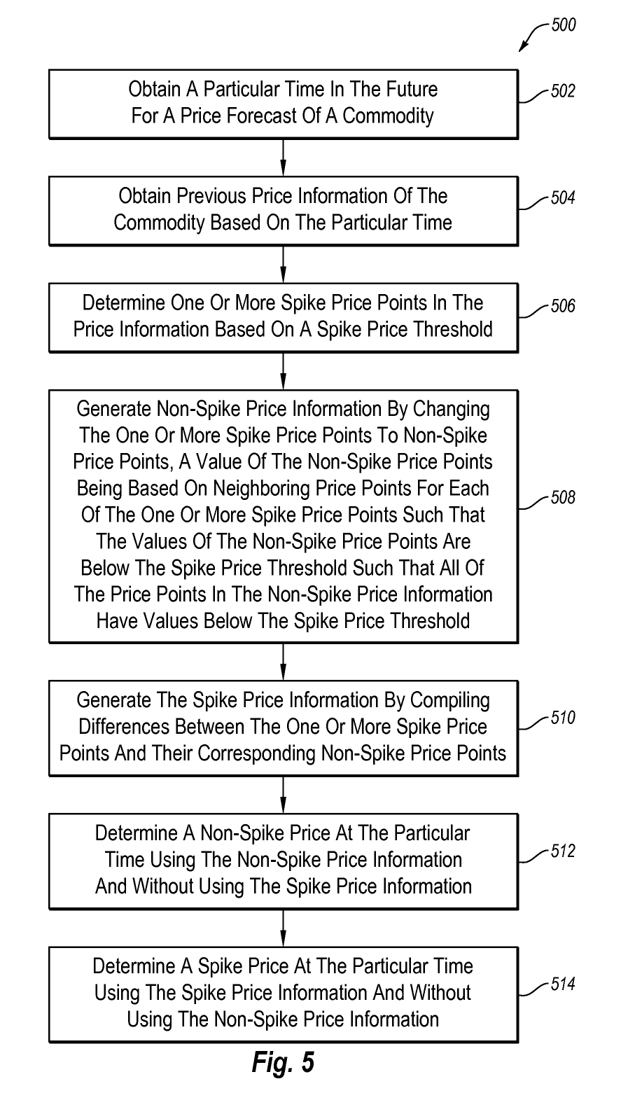

FIG. 3 illustrates an example system 300 configured to forecast price of a commodity, arranged in accordance with at least one embodiment of the present disclosure. Generally, the system 300 may include any hardware, software, or both hardware and software that may be used to forecast price of a commodity. For example, the system 300 may include hardware, software, or both hardware and software used to perform the process illustrated in FIG. 1 and/or the methods illustrated in FIGS. 4 and 5.

As illustrated in FIG. 3, the system 300 may include a forecast system 310, which includes a processor 312, a memory 314, communication module 316, and an I/O device 318; a first database 320, a second database 330, and a network 302.

The network 302 may be configured to communicatively couple the forecast system 310 and the second database 330. The network 302 may be any wireless, wired, local, or external network of any type, configuration, or protocol. The network 302 may include one or more servers or other processors to enable the communication between systems through the network 302.

The second database 330 may be configured to store price information 332 and load information 334 about a commodity. The price information 332 may be similar to the price information 106 of FIG. 1. The load information 334 may be similar to the load information 108 of FIG. 1. In some embodiments, the price information 332 and the load information 334 may be provided to the second database 330 by a commodity market of the commodity. Upon request from another system, the second database 330 may be configured to provide the price information 332 and the load information 334 over the network 302.

The first database 320 may include training data 322, a spike detection algorithm 324, a spike price algorithm 326, and a non-spike price algorithm 328. The training data 322 may include previous price and load information about the commodity. For example, the training data 322 may include previous real-time price information, previous future market clearing prices, previous real-time load prices, and previous forecasted load prices. The training data may be obtained, for example, from the second database 330.

A system, such as the forecast system 310, may be configured to generate the spike detection algorithm 324, the spike price algorithm 326, and the non-spike price algorithm 328 from the training data using machine learning. For example, the training data may be used to generate features in a similar manner as the feature generation 130 of FIG. 1. In some embodiments, the features used to train the spike detection algorithm 324, the spike price algorithms 326, and the non-spike price algorithm 328 may be similar or the same as the features provided to the algorithms 150 of FIG. 1. Thus, the spike detection algorithm 324 may be trained using features with spike and non-spike price data, the spike price algorithms 326 may be trained using spike price data, and the non-spike price algorithm 328 may be trained using non-spike price data.

In some embodiments, the training data 322 may be updated or added to at particular intervals, such as daily, weekly, bi-weekly, monthly, etc. After a change in the training data 322, the spike detection algorithm 324, the spike price algorithms 326, and the non-spike price algorithm 328 may be retrained with the updated training data 322.

In some embodiments, the spike price algorithms 326 may be generated using a self-organizing map machine learning algorithm. In these and other embodiments, a particular number of features may be used when generating the spike price algorithms 326. For each of the spike price algorithms 326, a subset of the particular number of features may be used. For example, a square of the particular number of features may be used. In these and other embodiments, the features in the subset may be randomly selected. Alternately or additionally, each of the spike price algorithms 326 may be generated using a different subset of the features for the spike price algorithms 326. In these and other embodiments, a number of spike price algorithms 326 generated may affect a training radius used in the self-organizing map machine learning algorithm. In particular, the training radius may have an inverse proportion to the number of the spike price algorithms 326 generated.

The forecast system 310 may be configured to forecast a price of a commodity. In some embodiments, the forecast system 310 may forecast a price of a commodity in a similar manner as a price is forecasted in the process 100 of FIG. 1 and the methods 400 and 500 of FIGS. 4 and 5.

The communication module 316 may be configured to communicate with the first and second databases 320 and 330. The communication module 316 may request and receive information from the first and second databases 320 and 330 for use in forecasting the price. For example, the communication module 316 may obtain the price information 332, the load information 334, the spike detection algorithm 324, the spike price algorithms 326, and the non-spike price algorithm 328.

The I/O device 318 may be configured to interface with a user. In these and other embodiments, the I/O device 318 may obtain an indication of particular time to forecast a price and may present a forecasted price for the particular time.

The processor 312 may be configured to use the price information 332, the load information 334, the spike detection algorithm 324, the spike price algorithms 326, the non-spike price algorithm 328, and the particular time to forecast a price at the particular time. In these and other embodiments, the price information 332, the load information 334, the spike detection algorithm 324, the spike price algorithms 326, the non-spike price algorithm 328, and the particular time may be loaded into the memory 314 along with computer-readable instructions to forecast a price. The processor 312 may execute the computer-readable instructions and use the price information 332, the load information 334, the spike detection algorithm 324, the spike price algorithms 326, the non-spike price algorithm 328, and the particular time to forecast a price. The forecasted price may be provided to the I/O device for presentation or to the communication module 316 for transmission to another system or device.

Generally, the processor 312 may include any suitable special-purpose or general-purpose computer, computing entity, or processing device including various computer hardware or software modules and may be configured to execute instructions stored on any applicable computer-readable storage media. For example, the processor 312 may include a microprocessor, a microcontroller, a digital signal processor (DSP), an application-specific integrated circuit (ASIC), a Field-Programmable Gate Array (FPGA), or any other digital or analog circuitry configured to interpret and/or to execute program instructions and/or to process data. Although illustrated as a single processor in FIG. 3, it is understood that the processor 312 may include any number of processors distributed across any number of network or physical locations that are configured to perform individually or collectively any number of operations described herein. In some embodiments, the processor 312 may interpret and/or execute program instructions and/or process data stored in the memory 314.

The memory 314 may include computer-readable storage media or one or more computer-readable storage mediums for carrying or having computer-executable instructions or data structures stored thereon. Such computer-readable storage media may be any available media that may be accessed by a general-purpose or special-purpose computer, such as the processor 312. By way of example, and not limitation, such computer-readable storage media may include non-transitory computer-readable storage media including Random Access Memory (RAM), Read-Only Memory (ROM), Electrically Erasable Programmable Read-Only Memory (EEPROM), Compact Disc Read-Only Memory (CD-ROM) or other optical disk storage, magnetic disk storage or other magnetic storage devices, flash memory devices (e.g., solid state memory devices), or any other storage medium which may be used to carry or store desired program code in the form of computer-executable instructions or data structures and which may be accessed by a general-purpose or special-purpose computer. Combinations of the above may also be included within the scope of computer-readable storage media. Computer-executable instructions may include, for example, instructions and data configured to cause the processor 312 to perform a certain operation or group of operations.

Modifications, additions, or omissions may be made to the system 300 without departing from the scope of the present disclosure. For example, the first database 320 may be part of the forecast system 310 or may be networked with the forecast system 310 through the network 302 or another network. In some embodiments, the forecast system 310 may generate the spike detection algorithm 324, the spike price algorithms 326, and the non-spike price algorithm 328.

FIG. 4 is a flow chart of an example method 400 to forecast price of a commodity, which may be arranged in accordance with at least one embodiment described herein. The method 400 may be implemented, in some embodiments, by a system, such as the system 300 of FIG. 3. Although illustrated as discrete blocks, various blocks may be divided into additional blocks, combined into fewer blocks, or eliminated, depending on the desired implementation.

The method 400 may begin at block 402, where a particular time in the future may be obtained for a price forecast of a commodity. The particular time may be provided from a user, a system, randomly generated, or otherwise obtained.

In block 404, previous price information of the commodity may be obtained based on the particular time. In block 406, the price information may be decomposed into spike price information and non-spike price information based on a spike price threshold.

In block 408, a non-spike price at the particular time may be determined using the non-spike price information. In some embodiments, the non-spike price at the particular time may be determined without using the spike price information. In block 410, it may be determined whether a price spike occurs at the particular time based on the price information.

In block 412, in response to the determination that the price spike does not occur at the particular time, the non-spike price may be provided as a forecasted price of the commodity at the particular time.

In block 414, in response to the determination that the price spike occurs at the particular time, a spike price may be provided as the forecasted price of the commodity at the particular time. The spike price at the particular time may be determined using the spike price information. In some embodiments, the spike price at the particular time may be determined without using the non-spike price information.

In some embodiments, the spike price at the particular time may be determined by applying the spike price information to multiple spike price algorithms. In these and other embodiments, the spike price may be based on outputs of the multiple spike price algorithms. In these and other embodiments, the multiple spike price algorithms may be generated using multiple features based on load information of the commodity and previous spike-price information of the commodity. Each of the multiple spike price algorithms may be constructed using a subset of the multiple features. In these and other embodiments, a first subset of the multiple features used to generate a first of the multiple spike price algorithms may be different from a second subset of the multiple features used to generate a second of the multiple spike price algorithms.

In some embodiments, determining the non-spike price may be performed using a first price algorithm. In these and other embodiments, determining whether the price spike occurs may be performed using a second price algorithm and determining the spike price may be performed using a third price algorithm. In these and other embodiments, the first, second, and third price algorithms may each be different price algorithms. In some embodiments, the first price algorithm may be a neural network algorithm, the second price algorithm may be a support vector machine, and the third price algorithm may be a self-organizing map.

One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

For example, the method 400 may further include obtaining first forecasted load information of the commodity at the particular time and obtaining second forecasted load information of the commodity ahead of the particular time. In these and other embodiments, the previous price information may include first previous price information, second previous price information, and a future market clearing price. The non-spike price at the particular time may be determined using the non-spike price information, the first forecasted load information, and the second forecasted load information. In these and other embodiments, whether the price spike occurs at the particular time may be determined based on the price information, the first forecasted load information, and the second forecasted load information. Furthermore, the spike price at the particular time may be determined using the spike price information, the first forecasted load information, and the second forecasted load information.

In some embodiments, decomposing the price information into the spike price information and the non-spike price information may further include determining one or more spike price points in the price information based on the spike price threshold. The decomposition of the price information may further include generating the non-spike price information by changing the one or more spike price points to non-spike price points. A value of the non-spike price points may be based on neighboring price points for each of the one or more spike price points such that the values of the non-spike price points are below the spike price threshold. As a result, in these and other embodiments, all of the price points in the non-spike price information may have values below the spike price threshold. The decomposition of the price information may further include generating the spike price information by compiling differences between the one or more spike price points and their corresponding non-spike price points.

FIG. 5 is a flow chart of another example method 500 to forecast price of a commodity, which may be arranged in accordance with at least one embodiment described herein. The method 500 may be implemented, in some embodiments, by a system, such as the system 300 of FIG. 3. Although illustrated as discrete blocks, various blocks may be divided into additional blocks, combined into fewer blocks, or eliminated, depending on the desired implementation.

The method 500 may begin at block 502, where a particular time may be obtained in the future for a price forecast of a commodity. In block 504, previous price information of the commodity may be obtained based on the particular time. In block 506, one or more spike price points in the price information may be determined based on a spike price threshold.

In block 508, non-spike price information may be generated by changing the one or more spike price points to non-spike price points. In these and other embodiments, a value of the non-spike price points may be based on neighboring price points for each of the one or more spike price points such that the values of the non-spike price points are below the spike price threshold. As a result, in these and other embodiments, all of the price points in the non-spike price information may have values below the spike price threshold.

In block 510, the spike price information may be generated by compiling differences between the one or more spike price points and their corresponding non-spike price points. In block 512, a non-spike price at the particular time may be determined using the non-spike price information and without using the spike price information. In block 514, a spike price at the particular time may be determined using the spike price information and without using the non-spike price information.

One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

For example, the method 500 may further include determining whether a price spike occurs at the particular time based on the price information. In response to the determination that the price spike does not occur at the particular time, the non-spike price may be provided as a forecasted price of the commodity at the particular time. In response to the determination that the price spike occurs at the particular time, the spike price may be provided as the forecasted price of the commodity at the particular time.

In these and other embodiments, determining the non-spike price may be performed using a first price algorithm, determining whether the price spike occurs may be performed using a second price algorithm, and determining the spike price may be performed using a third price algorithm. In these and other embodiments, the first, second, and third price algorithms may each be different price algorithms constructed using different training data.

In some embodiments, the spike price at the particular time may be determined by applying the spike price information to multiple spike price algorithms. In these and other embodiments, the spike price may be based on outputs of the multiple spike price algorithms. The multiple spike price algorithms may be generated using multiple features based on load information of the commodity and previous spike-price information of the commodity. In some embodiments, each of the multiple spike price algorithms may be constructed using a subset of the multiple features. A first subset of the multiple features used to generate a first of the multiple spike price algorithms may be different from a second subset of the multiple features used to generate a second of the multiple spike price algorithms.

While some of the systems and methods described herein are generally described as being implemented in software (stored on and/or executed by general purpose hardware), specific hardware implementations or a combination of software and specific hardware implementations are also possible and contemplated. In this description, a “computing entity” may be any computing system as previously defined herein, or any module or combination of modulates running on a computing system.

Terms used herein and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc. For example, the use of the term “and/or” is intended to be construed in this manner.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

All examples and conditional language recited herein are intended for pedagogical objects to aid the reader in understanding the invention and the concepts contributed by the inventor to furthering the art, and are to be construed as being without limitation to such specifically recited examples and conditions. Although embodiments of the present disclosure have been described in detail, it should be understood that the various changes, substitutions, and alterations could be made hereto without departing from the spirit and scope of the present disclosure.

What is claimed is:

1. A method to forecast price of a commodity, the method comprising:
obtaining a particular time in the future for a price forecast of a commodity;
obtaining previous price information of the commodity based on the particular time;
decomposing the price information into spike price information and non-spike price information based on a spike price threshold;
determining, using a first machine learning price algorithm, a non-spike price at the particular time based on the non-spike price information;
determining, using a second machine learning price algorithm, whether a price spike occurs at the particular time based on the price information; and
providing a forecasted price of the commodity at the particular time, the forecasted price of the commodity being the non-spike price in response to the determination that the price spike does not occur at the particular time and the forecasted price of the commodity being a spike price in response to the determination that the price spike occurs at the particular time, the spike price at the particular time determined based on the spike price information using a third machine learning price algorithm.

2. The method of claim 1, wherein the first, second, and third machine learning price algorithms are each different machine learning price algorithms.

3. The method of claim 2, wherein the first machine learning price algorithm is a neural network algorithm, the second machine learning price algorithm is a support vector machine, and the third machine learning price algorithm is a self-organizing map.

4. The method of claim 1, wherein the non-spike price at the particular time is determined without using the spike price information and the spike price at the particular time is determined without using the non-spike price information.

5. The method of claim 1, wherein decomposing the price information into the spike price information and the non-spike price information further comprises:
determining one or more spike price points in the price information based on the spike price threshold;
generating the non-spike price information by changing the one or more spike price points to non-spike price points, wherein a value of the non-spike price points is based on neighboring price points for each of the one or more spike price points such that the values of the non-spike price points are below the spike price threshold such that all of the price points in the non-spike price information have values below the spike price threshold; and
generating the spike price information by compiling differences between the one or more spike price points and their corresponding non-spike price points.

6. The method of claim 1, further comprising:
obtaining first forecasted load information of the commodity at the particular time; and
obtaining second forecasted load information of the commodity ahead of the particular time,
wherein the previous price information includes first previous price information, second previous price information, and a future market clearing price,
the non-spike price at the particular time is determined using the non-spike price information, the first forecasted load information, and the second forecasted load information,
whether the price spike occurs at the particular time is determined based on the price information, the first forecasted load information, and the second forecasted load information, and
the spike price at the particular time is determined using the spike price information, the first forecasted load information, and the second forecasted load information.

7. The method of claim 1, wherein the spike price at the particular time is determined by applying the spike price information to a plurality of machine learning spike price algorithms, wherein the spike price is based on outputs of the plurality of machine learning spike price algorithms.

8. The method of claim 7, wherein the spike price at the particular time is a mean of the outputs of the plurality of machine learning spike price algorithms, the method further comprising generating a confidence interval with respect to the mean of the outputs of the plurality of machine learning spike price algorithms based on a probability distribution function of the outputs of the plurality of machine learning spike price algorithms.

9. The method of claim 7, wherein the plurality of machine learning spike price algorithms are generated using a plurality of features based on load information of the commodity and previous spike-price information of the commodity, wherein each of the plurality of machine learning spike price algorithms is constructed using a subset of the plurality of features, wherein a first subset of the plurality of features used to generate a first of the plurality of machine learning spike price algorithms is different from a second subset of the plurality of features used to generate a second of the plurality of machine learning spike price algorithms.

10. One or more non-transitory computer readable media that include instructions that when executed by one or more processors perform operations to forecast price of a commodity, the operations comprising:
obtaining a particular time in the future for a price forecast of a commodity;
obtaining previous price information of the commodity based on the particular time;
decomposing the price information into spike price information and non-spike price information based on a spike price threshold;
determining, using a first machine learning price algorithm, a non-spike price at the particular time based on the non-spike price information;
determining, using a second machine learning price algorithm, whether a price spike occurs at the particular time based on the price information; and
providing a forecasted price of the commodity at the particular time, the forecasted price of the commodity being the non-spike price in response to the determination that the price spike does not occur at the particular time and the forecasted price of the commodity being a spike price in response to the determination that the price spike occurs at the particular time, the spike price at the particular time determined based on the spike price information using a third machine learning price algorithm.

11. The one or more non-transitory computer readable media of claim 10, wherein the first machine learning price algorithm is a neural network algorithm, the second machine learning price algorithm is a support vector machine, and the third machine learning price algorithm is a self-organizing map.

12. The one or more non-transitory computer readable media of claim 10, wherein the non-spike price at the particular time is determined without using the spike price information and the spike price at the particular time is determined without using the non-spike price information.

13. The one or more non-transitory computer readable media of claim 10, wherein decomposing the price information into the spike price information and the non-spike price information includes operations comprising:
determining one or more spike price points in the price information based on the spike price threshold;
generating the non-spike price information by changing the one or more spike price points to non-spike price points, wherein a value of the non-spike price points is based on neighboring price points for each of the one or more spike price points such that the values of the non-spike price points are below the spike price threshold such that all of the price points in the non-spike price information have values below the spike price threshold; and
generating the spike price information by compiling differences between the one or more spike price points and their corresponding non-spike price points.

14. The one or more non-transitory computer readable media of claim 10, wherein the operations further comprise:
obtaining first forecasted load information of the commodity at the particular time; and
obtaining second forecasted load information of the commodity ahead of the particular time,
wherein the previous price information includes first previous price information, second previous price information, and a future market clearing price,
the non-spike price at the particular time is determined using the non-spike price information, the first forecasted load information, and the second forecasted load information,
whether the price spike occurs at the particular time is determined based on the price information, the first forecasted load information, and the second forecasted load information, and
the spike price at the particular time is determined using the spike price information, the first forecasted load information, and the second forecasted load information.

15. The one or more non-transitory computer readable media of claim 10, wherein the spike price at the particular time is determined by applying the spike price information to a plurality of machine learning spike price algorithms, wherein the spike price is based on outputs of the plurality of machine learning spike price algorithms.

16. The one or more non-transitory computer readable media of claim 15, wherein the plurality of machine learning spike price algorithms are generated using a plurality of features based on load information of the commodity and previous spike-price information of the commodity, wherein each of the plurality of machine learning spike price algorithms is constructed using a subset of the plurality of features, wherein a first subset of the plurality of features used to generate a first of the plurality of machine learning spike price algorithms is different from a second subset of the plurality of features used to generate a second of the plurality of machine learning spike price algorithms.

17. A method to forecast price of a commodity, the method comprising:
obtaining a particular time in the future for a price forecast of a commodity;
obtaining previous price information of the commodity based on the particular time;
determining one or more spike price points in the price information based on a spike price threshold;
generating non-spike price information by changing the one or more spike price points to non-spike price points, a value of the non-spike price points being based on neighboring price points for each of the one or more spike price points such that the values of the non-spike price points are below the spike price threshold such that all of the price points in the non-spike price information have values below the spike price threshold;
generating the spike price information by compiling differences between the one or more spike price points and their corresponding non-spike price points;
determining, using a first machine learning price algorithm, a non-spike price at the particular time using the non-spike price information and without using the spike price information; and
determining, using a second machine learning price algorithm, a spike price at the particular time using the spike price information and without using the non-spike price information.

18. The method of claim 17, further comprising:
determining, using a third machine learning price algorithm, whether a price spike occurs at the particular time based on the price information; and
providing a forecasted price of the commodity at the particular time, the forecasted price of the commodity being the non-spike price in response to the determination that the price spike does not occur at the particular time and the forecasted price of the commodity being the spike price in response to the determination that the price spike occurs at the particular time.

19. The method of claim 18, wherein the first, second, and third machine learning price algorithms are each different price algorithms constructed using different training data.

20. The method of claim 19, wherein the spike price at the particular time is determined by applying the spike price information to a plurality of machine learning spike price algorithms,
wherein the spike price is based on outputs of the plurality of machine learning spike price algorithms, wherein the plurality of machine learning spike price algorithms are generated using a plurality of features based on load information of the commodity and previous spike-price information of the commodity, and
wherein each of the plurality of machine learning spike price algorithms is constructed using a subset of the plurality of features, wherein a first subset of the plurality of features used to generate a first of the plurality of machine learning spike price algorithms is different from a second subset of the plurality of features used to generate a second of the plurality of machine learning spike price algorithms.
